(19) United States
(12) Patent Application Publication
(10) Pub. No.: US 2003/0154916 A1
(43) Pub. Date: Aug. 21, 2003

(54) Pump equipment for coating apparatus

(75) Inventors: Hideaki Takekuma, Odawara-shi (JP); Kazuyki Soga, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/366,615

(22) Filed: Feb. 14, 2003

(30) Foreign Application Priority Data
Feb. 15, 2002 (JP) 2002-037831

(51) Int. Cl. B05C 5/00

(52) U.S. Cl. 118/300; 417/572

(57) ABSTRACT

There is provided pump equipment for a coating apparatus, which has liquid supply accuracy capable of accommodating thinner coating film formed on a flexible substrate and more stringent thickness variation standard. In a coating apparatus for applying a coating liquid to a continuously running flexible substrate, pump equipment is constructed so that a positive displacement rotary type or positive displacement reciprocating type gear pump for supplying the coating liquid to a coating head of the coating apparatus is installed on a truck. The truck has a stiffness such that the maximum vertical warp is not larger than 0.3 mm in a state in which the pump equipment is disposed on the uneven ground.

### BACKGROUND OF THE INVENTION

1 . Field of the Invention

The present invention relates to pump equipment for a coating apparatus and, more particularly, to an improvement in pump equipment for a coating apparatus which applies a coating liquid such as photo-sensitive liquid, magnetic liquid, surface protective layer liquid, undercoating liquid, and lubricating liquid to a flexible substrate (hereinafter referred to as “web”) running continuously.

2. Description of the Related Art

Coating apparatuses are broadly classified into two types: a post-metering type coating apparatus in which a coating liquid of an amount larger than a desired coating amount is applied to a continuously running web, and thereafter the coating amount is decreased to the desired value; and a pre-metering type coating apparatus in which a coating liquid that has been metered in advance so that a desired coating amount can be provided is applied to a continuously running web. The post-metering type coating apparatuses include a blade coating apparatus and a rod coating apparatus, and the pre-metering type coating apparatuses include an extrusion coating apparatus and a curtain coating apparatus.

Among the pre-metering type coating apparatuses, the extrusion coating apparatus has been commonly used because it can perform thin layer coating at a high speed as compared with other coating apparatuses. One of the systems for supplying a coating liquid to a coating head of extrusion coating apparatus is an extraction difference system (e.g., Japanese Patent No. 2530202). In this extraction difference system, a coating liquid is applied to a web so that the coating amount is a difference between the amount of liquid supplied to the coating head and the amount of liquid extracted from the coating head, and an extraction pump is disposed in a coating liquid extracting system provided in the coating apparatus, by which some of coating liquid supplied to the coating head by a supply pump is extracted by the extraction pump.

Another liquid supplying system is a closed circulation system (e.g., Japanese Patent No. 3041741). In this closed circulation system, one circulation extraction pump is provided so that the coating liquid is supplied to and extracted from the coating head. In this system, a fixed amount of coating liquid is supplied to the closed circulation system, and the coating liquid is applied to a web so that the coating amount is the amount of supplied liquid.

In the pre-metering type coating apparatus, the coating liquid must be metered so as to have a desired coating amount in advance. Therefore, high liquid supply accuracy of pump is required, so that a positive displacement rotary type or positive displacement reciprocating type pump that is suitable for supplying a fixed amount of coating liquid has been used.

In recent years, magnetic recording media such as a magnetic recording tape, particularly for broadcasting or computer use, that are manufactured by applying a magnetic liquid to a web have been rapidly improved in capacity and recording density. Accordingly, the thickness standard for a magnetic layer that serves for recording has become thinner, and also the thickness variation standard for variations in thickness has become more stringent.

The pre-metering type coating apparatus has a problem in that as the thickness standard becomes thinner, or as the thickness variation standard becomes more stringent, the liquid supply accuracy of the conventional positive displacement rotary type or positive displacement reciprocating type pump cannot meet the standard. As a result, because of insufficient liquid supply accuracy of pump, the thickness of obtained coating film is larger than the thickness specified in the standard, or a coating defect such as uneven coating due to the pulsation of pump occurs.

In particular, in the above-described extrusion coating apparatus of extraction difference system, since two pumps are used for supply and extraction, the thickness variation is a value corresponding to the sum of variations in the two pumps, so that pumps having high liquid supply accuracy are required still more.

With such a background, a proposal has been made in Japanese Patent Application P2001-196998 (corresponding to Japanese Patent Application Publication P2003-13845A, which was, at the time the present invention was made, not published, not publically known, and assigned to the same assignee to which the present invention was subject to an obligation of assignment) to increase the liquid supply accuracy of the pump itself, in which the liquid supply accuracy of pump is increased by the use of a flywheel.

However, even if the liquid supply accuracy of the pump itself is increased, the occurrence of troubles in actual operation has frequently been experienced. The reason for this is as described below. The pump is often moved within a process usually as pump equipment installed on a truck. At this time, the place at which the pump equipment is disposed is not necessarily the flat ground and is often the uneven ground. In this case, the truck may be warped or twisted. As a result, a shift (misalignment) is produced between the axis of the driving shaft of pump and the axis of a power source such as a motor, which results in poor liquid supply accuracy of pump.

### SUMMARY OF THE INVENTION

The present invention has been made in view of the above situation, and accordingly an object thereof is to provide pump equipment for a coating apparatus, which has liquid supply accuracy capable of accommodating thinner coating film and more stringent thickness variation standard.

To attain the above object, the present invention is directed to pump equipment for a coating apparatus for applying a coating liquid to a continuously running flexible substrate, in which one of a positive displacement rotary type pump and a positive displacement reciprocating type pump for supplying the coating liquid to a coating head of the coating apparatus is installed on a truck, wherein the truck has a stiffness such that a maximum vertical warp thereof is not larger than 0.3 mm in a state in which the truck is disposed on an uneven ground.

According to the present invention, even if the pump equipment is disposed on the uneven ground, the truck is not warped or twisted because of its sufficient stiffness, and a shift does not occur between the axis of the driving shaft of pump and the axis of a power source such as a motor. Therefore, the liquid supply accuracy of pump can accommodate thinner coating film and more stringent thickness variation standard.

The present invention can be applied to all types of coating apparatuses, and in particular, it has a pronounced effect when being applied to a pre-metering type coating apparatus in which a coating liquid that has been metered so that a desired coating amount can be provided is applied to a continuously running flexible substrate.

Usually, the truck has a rectangular shape in plan view, and four casters are generally provided near four corners on the bottom surface. When such a truck is disposed on the uneven ground, if the truck has a sufficient stiffness, only three casters are in contact with the ground, and the remaining one caster floats.

Contrarily, if the truck does not have a sufficient stiffness, three casters are in contact with the ground as described above, and the remaining one caster does not float and is in contact with the ground due to the warp of truck.

In the present invention, a case of extremely uneven ground in which only two casters at diagonal positions of the truck are in contact with the ground is not considered. A truck having a stiffness such as to accommodate such an extremely uneven ground is actually difficult to realize, and also the truck having such a stiffness is not profitable.

Also, a configuration in which three casters are provided on the truck, for example, a configuration in which when the truck has a rectangular shape in plan view, casters are provided at both ends of one short side of rectangle and in the center of the other short side thereof does not cause any trouble when the truck is disposed on the uneven ground. Usually, however, such a configuration is rarely adopted.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a construction view of a coating apparatus provided with a liquid supply system of extraction difference system in which pump equipment in accordance with the present invention is incorporated;

FIG. 2 is an explanatory view for illustrating an extrusion type coating head;

FIG. 3 is a general construction view of pump equipment (gear pump equipment) in accordance with the present invention;

FIG. 4 is a general construction view of pump equipment (plunger pump equipment) in accordance with the present invention;

FIGS. 5(a) and 5(b) are construction views of a gear pump of the pump equipment in accordance with the present invention; and

FIG. 6 is a construction view of a plunger pump of the pump equipment in accordance with the present invention.

### DETAILED DESCRIPTION OF THE PREFERRED EMBODIMENTS

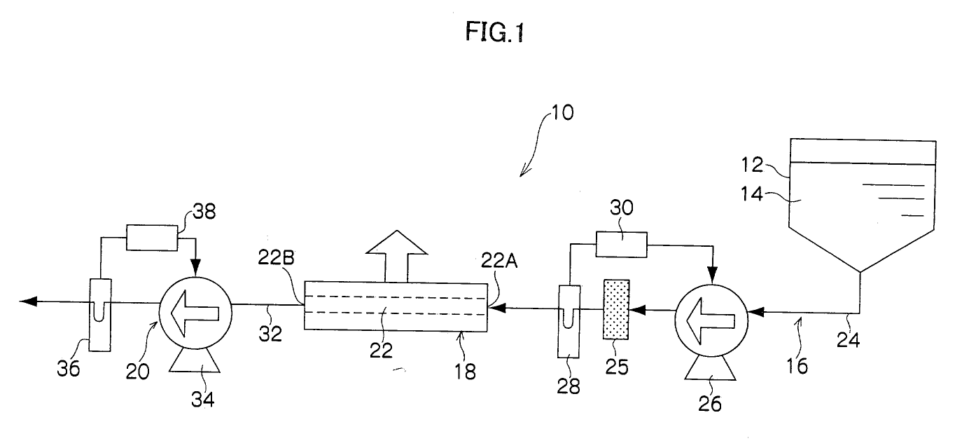

A preferred embodiment of pump equipment for a coating apparatus in accordance with the present invention will now be described in detail with reference to the accompanying drawings. FIG. 1 is a general construction view of a coating apparatus provided with a liquid supply system of extraction difference system, showing an embodiment of a pre-metering type coating apparatus incorporating pump equipment in accordance with the present invention.

As shown in FIG. 1, a coating apparatus 10 of extraction difference system is composed of a supply system 16 and an extraction system 20. A coating liquid 14 stored in a storage tank 12 is supplied to a coating head 18 by the supply system 16, and at the same time, some of the coating liquid 14 having been supplied to the coating head 18 is extracted by the extraction system 20.

The supply system 16 has a supply pipe 24 that connects the storage tank 12 to an inlet 22A of a pocket portion 22 of the coating head 18. The supply pipe 24 is provided with a liquid supply pump 26, a filter 25 for filtrating the coating liquid 14, and a flowmeter 28 for measuring the supply flow rate in that order from the storage tank 12 side. Also, the supply system 16 is configured so that a supply controller 30 controls the liquid supply pump 26 based on a flow rate detection signal sent from the flowmeter 28. Thereby, the supply amount of coating liquid supplied to the coating head 18 can be controlled.

The extraction system 20 has an extraction pipe 32 that is connected to an outlet 22B of the pocket portion 22 of the coating head 18. The extraction pipe 32 is provided with an extraction pump 34 and a flowmeter 36 for measuring the extraction flow rate in that order from the coating head 18 side. Also, the extraction system 20 is configured so that an extraction controller 38 controls the extraction pump 34 based on a flow rate detection signal sent from the flowmeter 36. Thereby, the extraction amount of coating liquid extracted from the coating head 18 can be controlled.

As the coating head 18, a coating head for pre-metering type coating apparatus, such as a coating head for extrusion coating or a coating head for curtain coating, can be used. Herein, explanation is given taking an example in which two-layer coating is performed at the same time with an extrusion coating head.

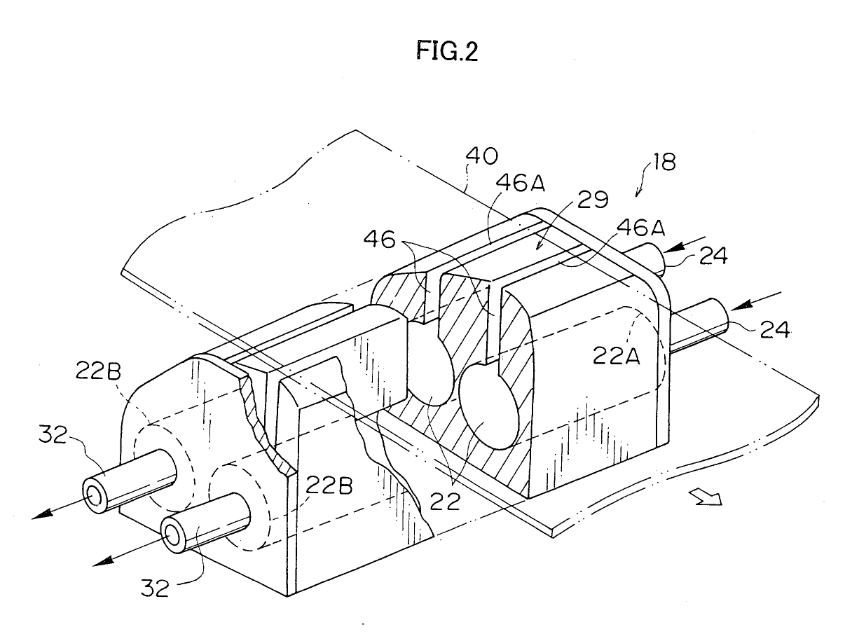

As shown in FIG. 2, the coating head 18 is formed with two cylindrical pocket portions 22, 22 that are parallel with each other in the widthwise direction of a web 40 in the interior thereof. The inlet 22A of the pocket portion 22 is connected with the supply pipe 24, and the outlet 22B of the pocket portion 22 is connected with the extraction pipe 32. The pocket portions 22, 22 communicates with slit tip ends 46A, 46A formed in an edge surface 29 of the coating head 18 via slits 46, 46 formed so as to substantially correspond to the coating width.

On the other hand, the web 40 to which the coating liquid 14 is applied is supported on a pair of guide rollers, not shown, on the upstream side and the downstream side on the opposite sides of the coating head 18. The web 40 runs continuously in a state of being close to the edge surface 29 of the coating head 18 by these guide rollers.

At the time of coating, a desired amount of coating liquid is discharged from the slit tip end 46A by the discharge-side pressure of the liquid supply pump 26 while the coating liquid 14 is supplied to the pocket portion 22 of the coating head 18 by the liquid supply pump 26 and, at the same time, some of the coating liquid 14 in the pocket portion 22 is extracted by the extraction pump 34. Thereby, the coating liquid 14 is applied to the web 40 so that the coating amount is a difference between the amount of liquid supplied to the coating head 18 and the amount of liquid extracted from the coating head 18.

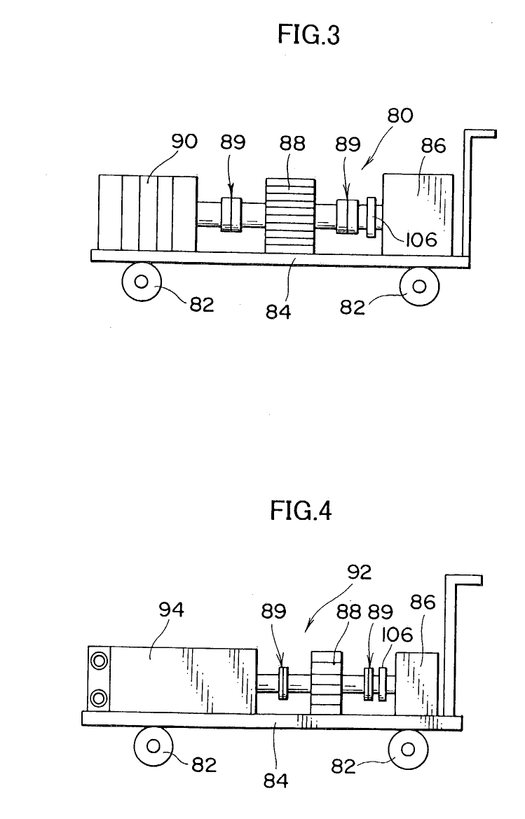

FIGS. 3 and 4 are general construction views of positive displacement rotary type pump equipment and a positive displacement reciprocating type pump equipment in accordance with the present invention, which are used as the liquid supply pump 26 and the extraction pump 34.

FIG. 3 shows an example in which a gear pump unit is used as pump equipment 80. The pump equipment 80 is constructed as a pump unit in which a motor 86, a reduction gear 88, couplings 89, and a gear pump 90 are integrally mounted on a truck 84 provided with four casters 82 near the four corners on the bottom surface thereof.

FIG. 4 shows an example in which a plunger pump unit is used as pump equipment 92. The pump equipment 92 is constructed as a pump unit in which the motor 86, the reduction gear 88, the couplings 89, and a plunger pump 94 are integrally mounted on a truck 84 provided with the four casters 82 near the four corners on the bottom surface thereof. In FIGS. 3 and 4, reference numeral 106 designates a flywheel, which will be described later.

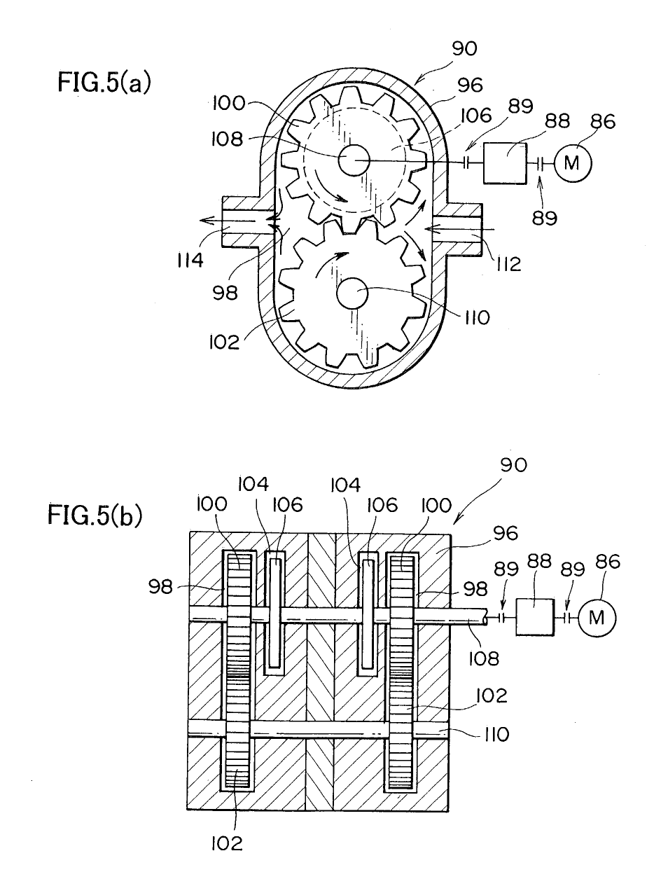

In the gear pump 90, as shown in FIGS. 5(a) and 5(b) by taking a double type as an example, a driving gear 100 supported on a driving shaft 108 and a driven gear 102 supported on a driven shaft 110 are housed in a gear chamber 98 in a casing 96. The driving shaft 108 is connected to a rotating shaft from the reduction gear 88 via the coupling 89, where if the shift of axes in the connection is large, great pulsation occurs.

The flywheel 106, which is housed in a flywheel chamber 104 in the casing 96, is supported on the driving shaft 108. The flywheel 106 may be provided between the coupling 89 on the motor 86 side of the reduction gear 88 and the motor 86 as shown in FIG. 3.

By the above-described construction, when the motor 86 is driven, the driving gear 100 and the driven gear 102 are engaged with each other and are rotated, by which the coating liquid 14 is sucked through a suction port 112 and is discharged through a discharge port 114.

In the present invention, the flywheel 106 is not an essential element. However, the inertia moment of the driving shaft 108 can be increased by the flywheel 106. By the action of the flywheel 106, the rotational speed of the driving shaft 108 is made constant against the load fluctuations of the gear pump 90. Therefore, even if load fluctuations occur in the gear pump 90, speed fluctuations are less liable to occur in the rotation of the motor 86. Thereby, the amount of the coating liquid 14 discharged through the discharge port 114 can be made constant, and also pulsation can be made less liable to occur.

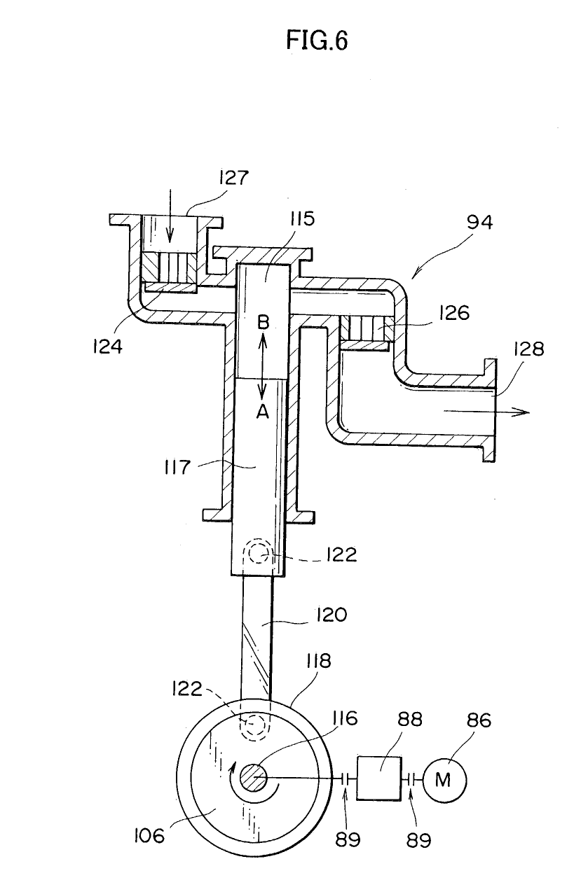

In the plunger pump 94, as shown in FIG. 6, a proximal end portion of a plunger 117 that reciprocates in a cylinder 115 and an outer circumferential portion of a rotating disk 118 supported on a driving shaft 116 by which the driving force of the motor 86 is transmitted are connected to each other via a rod 120 by pins 122, 122.

Also, the flywheel 106 is supported on the driving shaft 116 by which the driving force is transmitted from the motor 86. The flywheel 106 may be provided between the coupling 89 on the motor 86 side of the reduction gear 88 and the motor 86 as shown in FIG. 4. Thereby, the rotating motion of the motor 86 is converted into the reciprocating motion of the plunger 117 by a crank mechanism comprising the rotating disk 118 and the rod 120.

When the plunger 117 is moved in the direction of arrow A, a suction valve 124 is opened and a discharge valve 126 is closed, so that the coating liquid 14 is sucked into the cylinder 115 through a suction port 127. When the plunger 117 is moved in the direction of arrow B, the discharge valve 126 is opened and the suction valve 124 is closed, so that the coating liquid 14 is discharged through a discharge port 128, and also the inertia moment of the driving shaft 116 can be increased by the flywheel 106.

By the action of the flywheel 106, the rotational speed of the driving shaft 116 is made constant against the load fluctuations of the plunger pump 94. Therefore, even if load fluctuations occur in the plunger pump 94, speed fluctuations do not occur in the rotation of the motor 86. Thereby, the amount of the coating liquid 14 discharged through the discharge port 128 can be made constant, and also pulsation can be made less liable to occur.

Next, the truck 84 shown in FIGS. 3 and 4 will be described. When the gear pump 90 was described before, an explanation that if the shift in axes between the driving shaft 108 and the rotating shaft is large, great pulsation occurs was given. This phenomenon also occurs between other shafts, and also occurs in the plunger pump 94 in the same manner.

Thereupon, minimization of shift in axes is of importance in obtaining a good coating film. Even if adjustment has been made in advance to minimize the shift in axes, shift in axes is caused by the warp or twisting of the truck 84. For this reason, it is necessary to give a stiffness not lower than a predetermined value to the truck 84.

Concretely, it was empirically verified that the truck 84 must have a stiffness such that the maximum vertical warp in a state in which the truck 84 is disposed on the uneven ground is not larger than 0.3 mm. In order to make the stiffness not smaller than the predetermined value, the geometrical moment of inertia has to be increased to cope with warp, and the polar moment of inertial of area has to be increased to cope with twisting.

Usually, the truck 84 is constructed by combining channels or angles made from structural steel or stainless steel by welding or other means. In this case, the construction should be such as to increase the geometrical moment of inertia and/or the polar moment of inertial of area.

The above is a description of the examples of embodiment of pump equipment for a coating apparatus in accordance with the present invention. The present invention is not limited to the above-described examples of embodiment, and various aspects can be taken. For example, although explanation has been given concerning the pre-metering type coating apparatus in this embodiment, a construction in which the present invention is applied to a post-metering type coating apparatus can be adopted.

### EXAMPLE

The pump equipment for a coating apparatus in accordance with the embodiment of the present invention was compared with the conventional pump equipment for a coating apparatus. As the web 40, a polyethylene terephthalate (PET) sheet with a width of 550 mm and a thickness of 9 μm was used.

As the coating liquid 14, coating liquid A (upper layer) and coating liquid B (lower layer) were used to perform two-layer coating. The running speed of the web 40 was set at 300 m/min, and the supply amount of the coating liquid 14 was set at 2 ml/m² for coating liquid A (upper layer) and 10 ml/m² for coating liquid B (lower layer). The coating start operation was repeated ten times under the same conditions, and unevenness etc. of coating film were evaluated. The composition of coating liquid A (upper layer) and coating liquid B (lower layer) is given below.

| | | |
|---|---|---|
| Ferromagnetic metal fine powder: | 100 | parts |
| Vinyl chloride copolymer | 12 | parts |
| MR100 (manufactured by Nippon Zeon): | | |
| Polyurethane resin | 3 | parts |
| UR8200 (manufactured by Toyobo): | | |
| α alumina | 10 | parts |
| H1T55 (manufactured by Sumitomo Chemical): | | |
| Carbon black | 5 | parts |
| #55 (manufactured by Asahi Carbon): | | |
| Phenylphosphonic acid: | 3 | parts |
| Butyl stearate: | 10 | parts |
| Butoxyethyl stearate: | 5 | parts |
| Isohexadecyl stearate: | 3 | parts |
| Stearic acid: | 2 | parts |
| Methyl ethyl ketone: | 100 | parts |
| Cyclohexane: | 100 | parts |

Coating Liquid B

| | | |
|---|---|---|
| Non-magnetic powder TiO₂ Crystalline rutile: | 80 | parts |
| Average primary particle size 0.035 μm, Specific surface | | |
| area by BET method 40 m²/g | | |
| PH7, TiO₂ content 90% or more | | |
| DBP oil absorption 27 to 38 g/100 g | | |
| Surface treatment agent Al₂O₃ 8 wt% | | |
| Carbon black | | |
| Conductex SC-U | 20 | parts |
| (manufactured by Columbian Carbon): | | |
| Vinyl chloride copolymer | 12 | parts |
| MR110 (manufactured by Nippon Zeon): | | |
| Polyurethane resin | 5 | parts |
| UR8200 (manufactured by Toyobo): | | |
| Phenylphosphonic acid: | 4 | parts |
| Butyl stearate: | 1 | part |
| Stearic acid: | 3 | parts |
| Methyl ethyl ketone/cyclohexane | 200 | parts |
| (8/2 mixed solvent): | | |

The results are given in Tables 1 and 2 presented below.

In both examples and comparative examples, in the coating of lower layer (coating liquid B), a gear pump was used, and both of the amount of ground unevenness and the warp of a truck were fixed to a condition of 0.05 mm. Therefore, the results given in Tables 1 and 2 are ones obtained by the coating of upper layer (coating liquid A).

Table 1 gives comparison results in the case where the amount of ground unevenness is 1 mm, and Table 2 gives comparison results in the case where the amount of ground unevenness is relatively small, being not larger than 1 mm.

TABLE 1

| | | Ground | Truck warp | Thickness variation in the | Film |
|---|---|---|---|---|---|
| | Pump | unevenness (mm) | (mm) | lengthwise direction (%) | unevenness |
| Example 1 | Gear | 1.0 | 0.05 | ±1 | A |
| Example 2 | Gear | 1.0 | 0.1 | ±2 | A |
| Example 3 | Gear | 1.0 | 0.3 | ±4 | B |
| Example 4 | Plunger | 1.0 | 0.05 | ±1 | A |
| Example 5 | Plunger | 1.0 | 0.1 | ±2 | A |
| Example 6 | Plunger | 1.0 | 0.3 | ±4 | B |
| Example 7 | Gear | 1.0 | 0.4 | ±6 | F |
| Example 8 | Plunger | 1.0 | 0.4 | ±6 | F |

TABLE 2

| | | Ground | Truck warp | Thickness variation in the | Film |
|---|---|---|---|---|---|
| | Pump | unevenness (mm) | (mm) | lengthwise direction (%) | unevenness |
| Example 1 | Gear | 0.05 | 0.05 | ±1 | A |
| Example 2 | Gear | 0.1 | 0.1 | ±2 | A |
| Example 3 | Gear | 0.3 | 0.3 | ±4 | B |
| Example 4 | Plunger | 0.05 | 0.05 | ±1 | A |
| Example 5 | Plunger | 0.1 | 0.1 | ±2 | A |
| Example 6 | Plunger | 0.3 | 0.3 | ±4 | B |
| Example 7 | Gear | 0.4 | 0.4 | ±6 | F |
| Example 8 | Plunger | 0.4 | 0.4 | ±6 | F |

Of the examples given in the tables, Examples 1 to 6 are examples using the pump equipment in accordance with the present invention, and Examples 7 and 8 are comparative examples using the conventional pump equipment. Regarding the pump, in the pump equipment in accordance with the present invention, a gear pump (Examples 1 to 3) and a plunger pump (Examples 4 to 6) were used, and in the comparative example, a gear pump was used in Example 7 and a plunger pump was used in Example 8. In both examples and comparative examples, the truck for pump equipment had a rectangular shape measuring 600×1400 mm in plan view.

The amount of ground unevenness at the site at which the pump equipment was disposed was measured by using a straightedge (ceramic bar having straightness) and a feeler gage. The measurement was made in the longitudinal, transverse, and diagonal directions, and the maximum value was taken as the amount of ground unevenness. The warp of truck was measured by measuring upper portions at four comers of truck with a laser type displacement sensor.

The thickness variation in the lengthwise direction was measured by using a VSM (film thickness measuring instrument). The unevenness of coating film was evaluated by visual sensory test, and was ranked as A: good, B: partially poor, and F: poor.

According to the results given in Table 1 in which the amount of ground unevenness is 1 mm, in all examples (Examples 1 to 6) of the present invention, the warp of truck was 0.3 mm or smaller, the thickness variation in the lengthwise direction was 4% or less, and the evaluation of coating film unevenness was good or partially poor. Contrarily, in comparative examples (Examples 7 and 8), the warp of truck was 0.4 mm, which is larger than 0.3 mm, the thickness variation in the lengthwise direction was 6%, and the evaluation of coating film unevenness was poor.

According to the results given in Table 2 in which the amount of ground unevenness is relatively small, in all examples (Examples 1 to 6) of the present invention, the warp of truck was 0.3 mm or smaller, the thickness variation in the lengthwise direction was 4% or less, and the evaluation of coating film unevenness was good or partially poor. Contrarily, in comparative examples (Examples 7 and 8), the warp of truck was 0.4 mm, which is larger than 0.3 mm, the thickness variation in the lengthwise direction was 6%, and the evaluation of coating film unevenness was poor.

As described above, according to the pump equipment for a coating apparatus in accordance with the present invention, there can be provided pump equipment for a coating apparatus, which has liquid supply accuracy capable of accommodating thinner coating film formed on a flexible substrate and more stringent thickness variation standard.

Thereby, even in the case where the wet thickness of coating film is very small, being not larger than 3 ml/m², a coating film having small thickness distribution can be formed.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. Pump equipment for a coating apparatus for applying a coating liquid to a continuously running flexible substrate, in which one of a positive displacement rotary type pump and a positive displacement reciprocating type pump for supplying the coating liquid to a coating head of the coating apparatus is installed on a truck, wherein the truck has a stiffness such that a maximum vertical warp thereof is not larger than 0.3 mm in a state in which the truck is disposed on an uneven ground.
